(19) United States
(12) Patent Application Publication
(10) Pub. No.: US 2008/0185087 A1
(43) Pub. Date: Aug. 7, 2008

(54) Tire and Crosslinkable Elastomeric Composition

(76) Inventors: Maurizio Galimberti, Milano (IT); Michela Caprio, Milano (IT); Luca Giannini, Milano (IT); Stefano Solinas, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/665,271

(22) PCT Filed: Oct. 15, 2004
(86) PCT No.: PCT/EP04/11674

§ 371 Date: Dec. 17, 2007

(51) Int. Cl. C08L 23/22; B60C 1/00; C08L 23/28; C08L 7/00; C08K 3/34

(52) U.S. Cl. 152/510; 525/240

(57) ABSTRACT

A tire, including a carcass structure, includes at least one carcass ply of a substantially toroidal shape, having opposite lateral edges associated with respective right-hand and left-hand bead structures, the bead structures including at least one bead core and at least one bead filler; a belt structure applied in a radially external position with respect to the carcass structure; a tread band radially superimposed on the belt structure; a pair of sidewalls applied laterally on opposite sides with respect to the carcass structure; and at least one layer including a crosslinked elastomeric material applied in a radially inner position with respect to the carcass structure. The crosslinked elastomeric material is obtained by crosslinking a crosslinkable elastomeric composition including (a) less than 50 phr, preferably 15 phr to 40 phr, of at least one butyl rubber; (b) not less than 50 phr, preferably 60 phr to 85 phr, of at least one polyisoprene rubber; and (c) 2 phr to 50 phr, preferably 5 phr to 35 phr, of at least one layered material. Preferably, the layer including a crosslinked elastomeric material is a tire innerliner.

### BACKGROUND OF THE INVENTION

The present invention relates to a tire and to a crosslinkable elastomeric composition.

More in particular the present invention relates to a tire comprising at least one layer including a crosslinked elastomeric material, said crosslinked elastomeric material being obtained by crosslinking a crosslinkable elastomeric composition comprising at least one butyl rubber, at least one polyisoprene rubber and at least one layered material.

Moreover, the present invention also relates to a crosslinkable elastomeric composition comprising at least one butyl rubber, at least one polyisoprene rubber and at least one layered material, as well as to a crosslinked manufactured article obtained by crosslinking said crosslinkable elastomeric composition.

### PRIOR ART

The inner surface of tires, in particular of tubeless tires, generally includes a layer of crosslinked elastomeric material which is designed to prevent or retard air and moisture permeation and to maintain tire pressure, so ensuring a hermetic seal of the tire when the tire is installed on a rim and inflated. Said layer is often referred to as “liner” or “innerliner”.

Butyl rubbers and/or halogenated butyl rubbers are commonly used for making tire innerliners because they are relatively impermeable to air and moisture and exhibit other desirable physical properties such as, for example, flex fatigue resistance and age durability.

It is also known to add layered clays to crosslinkable elastomeric compositions in order to improve air barrier properties.

For example, International Patent Application WO/0248257 relates to an elastomeric composition including an isobutylene-based copolymer such as, for example, a halogenated poly(isobutylene-co-p-methylstyrene), halogenated star branched butyl rubber, halogenated butyl rubber, or mixture thereof, at least one filler such as, for example, calcium carbonate, silica, carbon black, and a polybutene oil having a number average molecular weight greater than 400. Said elastomeric composition may also include an exfoliated clay which may be selected from natural or synthetic phyllosilicate, particularly smectite clays such as, for example, montmorillonite. The abovementioned elastomeric composition is said to have improved air barrier properties and processing properties and to be particularly useful as an air barrier.

International Patent Application WO 02/100936 relates to a nanocomposite comprising a clay, an interpolymer, one or more exfoliating additives, wherein the exfoliating additive is an amine having the structure R²R³R⁴N, wherein R², R³ and R⁴ are C₁ to C₂₀ alkyls or alkenes which may be identical or different. The interpolymer may be a copolymer of a C₄ to C₇ isomonoolefin derived units, a para-methylstyrene derived units and a para(halomethylstyrene) derived units. The clay may be selected from natural or synthetic phyllosilicate, particularly smectite clays such as, for example, montmorillonite. The abovementioned nanocomposite is said to have improved air barrier properties. A tire innerliner and a tire innertube comprising said nanocomposite are also disclosed.

International Patent Application WO 2004/005388 relates to a nanocomposite comprising a clay and an elastomer comprising C₂ to C₁₀ olefin derived units, wherein said elastomer also comprises functionalized monomer units pendant to the elastomer. Preferably, the elastomer is selected from poly(isobutylene-co-p-alkylstyrene) elastomers and poly(isobutylene-co-isoprene) elastomers, which are functionalized by reacting free radical generating agents and unsaturated carboxylic acids, unsaturated esters, unsaturated imides, and the like, with the elastomer. The abovementioned nanocomposite is said to have improved air barrier properties and to be particularly useful for tire innerliner and innertubes.

European Patent Application EP 1,408,074 relates to a rubber compound comprising at least one solid, optionally halogenated, butyl elastomer and at least one nanoclay such as natural or synthetic clays, optionally modified with organic modifiers, such as, for example, smectite clays (for example, sodium or calcium montrnorillonite). The abovementioned rubber compound is said to have low die swell, less mill shrinkage, faster extrusion times and improved heat aging combined with a lower Mooney scorch. The abovementioned rubber compound is said to be particularly suitable for a number of applications such as, for example, tire treads and tire sidewalls, tire innerliners, tank linings, hoses, rollers, conveyors belts, curing bladders, gas masks, pharmaceutical enclosures and gaskets.

Japanese Patent Application 2003/335902 relates to a rubber composition formed by mixing 100 parts by weight of solid rubber and 1-150 parts by weight of an organically treated layered mineral clay, which further includes 1-50 parts by weight of liquid rubber having an ammonium salt structure produced from liquid rubber containing a maleic anhydride structure, said liquid rubber being used as a compatibilizing agent for said solid rubber and layered mineral clay. The solid rubber may be selected from diene rubber or hydrogenated diene rubber, olefin rubber, halogen containing rubber, silicone rubber, thermoplastic rubber. The organically treated layered clay may be selected from natural or synthetic clays such as smectites (for example, montmorillonite). The abovementioned rubber composition is said to be useful for pneumatic tires innerliners.

However, the use of butyl rubbers and/or halogenated butyl rubbers may cause some drawbacks. For example, in particular butyl rubbers, show a scarce adhesion to the other elastomeric structural elements of the tire and, consequently, detachments in the tire structure may occur both during manufacturing and during use of the same. For example, it is difficult to adhere a butyl rubber to natural rubber or styrene/butadiene rubber.

In order to overcome the above reported drawbacks, halogenated butyl rubbers have been used. The halogenated butyl rubbers have air barriers properties substantially similar to that of butyl rubbers and, moreover, it can be adhered to both natural rubber and styrene/butadiene rubber. However, notwithstanding their good adhesion and air barrier properties, the halogenated butyl rubbers show a high degree of shrinkage in the non-crosslinked state and, therefore, the processability of the same is deteriorated so causing problems during tires manufacturing. For example, during the molding of the crude tires (before the crosslinking step), exfoliation may occur between a part of the halogenated butyl rubber and a part of an elastomeric structural element of the tire to which said halogenated butyl rubber is adhered (for example, between a part of the innerliner made from halogenated butyl rubber and a part of a carcass ply) owing to the increased self-shrinking force. In addition, after being formed into a structural element of the tire (for example, into an innerliner), there is a problem with regard to the accuracy and the dimension stability of the so obtained structural element which further increase its degree of shrinkage. Furthermore, it is difficult to form a halogenated butyl rubber into a thin film having a homogeneous thickness.

### SUMMARY OF THE INVENTION

The Applicant has now found that it is possible to obtain crosslinkable elastomeric compositions that may be advantageously used in the manufacturing of crosslinked manufactured products, in particular in the manufacturing of tires, more in particular in the manufacturing of tire innerliners, by using a low amount of at least one butyl rubber in combination with at least one polyisoprene rubber and at least one layered material.

Said crosslinkable elastomeric compositions show improved air barrier properties notwithstanding the presence of a low amount of butyl rubber. Moreover, a better adhesion to the other elastomeric structural elements of the tire is achieved and, consequently, detachments in the tire structure are avoided both during manufacturing and during use of the same. Said improvements are obtained without negatively affecting mechanical properties, both static and dynamic (in particular, tensile modulus and elastic modulus), of the crosslinked elastomeric compositions. Moreover, also flexural fatigue resistance of the crosslinked elastomeric compositions are suitable for using said elastomeric compositions in tires, particularly as a material for a tire innerliner. Furthermore, a good processability and extrudability of the same is obtained as showed by their viscosity values.

According to a first aspect, the present invention relates to a tire comprising:

a carcass structure comprising at least one carcass ply, of a substantially toroidal shape, having opposite lateral edges associated with respective right-hand and left-hand bead structures, said bead structures comprising at least one bead core and at least one bead filler;

a belt structure applied in a radially external position with respect to said carcass structure;

a tread band radially superimposed on said belt structure;

a pair of sidewalls applied laterally on opposite sides with respect to said carcass structure;

at least one layer including a crosslinked elastomeric material applied in a radially inner position with respect to said carcass structure;

wherein said crosslinked elastomeric material is obtained by crosslinking a crosslinkable elastomeric composition comprising:
(a) an amount lower than 50 phr, preferably of from 15 phr to 40 phr, of at least one butyl rubber;
(b) an amount not lower than 50 phr, preferably of from 60 phr to 85 phr, of at least one polyisoprene rubber;
(c) an amount of from 2 phr to 50 phr, preferably of from 5 phr to 35 phr, of at least one layered material.

Preferably, said layered material has an individual layer thickness of from 0.01 nm to 30 nm, more preferably of from 0.05 nm to 15 nm.

For the purposes of the present description and of the claims which follow, the term “phr” means the parts by weight of a given component of the elastomeric composition per 100 parts by weight of the rubber.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, said layer including a crosslinked elastomeric material is a tire innerliner.

According to another embodiment, said at least one carcass ply includes a crosslinked elastomeric material which is obtained by crosslinking a crosslinkable elastomeric composition comprising:

(a) an amount lower than 50 phr, preferably of from 15 phr to 40 phr, of at least one butyl rubber;
(b) an amount not lower than 50 phr, preferably of from 60 phr to 85 phr, of at least one polyisoprene rubber;
(c) an amount of from 2 phr to 50 phr, preferably of from 5 phr to 35 phr, of at least one layered material.

According to a further aspect, the present invention relates to a tire comprising:

a carcass structure comprising at least one carcass ply, of a substantially toroidal shape, having opposite lateral edges associated with respective right-hand and left-hand bead structures, said bead structures comprising at least one bead core and at least one bead filler;

a belt structure applied in a radially external position with respect to said carcass structure;

a tread band radially superimposed on said belt structure;

a pair of sidewalls applied laterally on opposite sides with respect to said carcass structure;

at least one innertube which fits inside said carcass structure;

wherein said at least one innertube includes a crosslinked elastomeric material which is obtained by crosslinking a crosslinkable elastomeric composition comprising:
(a) an amount lower than 50 phr, preferably of from 15 phr to 40 phr, of at least one butyl rubber;
(b) an amount not lower than 50 phr, preferably of from 60 phr to 85 phr, of at least one polyisoprene rubber;
(c) an amount of from 2 phr to 50 phr, preferably of from 5 phr to 35 phr, of at least one layered material.

According to a further aspect, the present invention relates to a crosslinkable elastomeric composition comprising:

(a) an amount lower than 50 phr, preferably of from 15 phr to 40 phr, of at least one butyl rubber;
(b) an amount not lower than 50 phr, preferably of from 60 phr to 85 phr, of at least one polyisoprene rubber;
(c) an amount of from 2 phr to 50 phr, preferably of from 5 phr to 35 phr, of at least one layered material.

According to one preferred embodiment, said polyisoprene rubber (b) may contain at least one functional group selected from: carboxylic groups, carboxylate groups, anhydride groups, ester groups, epoxy groups.

According to a further preferred embodiment, said polyisoprene rubber (b) includes from 0.05% by weight to 10% by weight, preferably from 0.1% by weight to 5% by weight, with respect to the total weight of the polyisoprene rubber, of said at least one functional group selected from: carboxylic groups, carboxylate groups, anhydride groups, ester groups.

The amount of functional groups present on the polyisoprene rubber (b) may be determined according to known techniques such as, for example, by Infrared ATR-spectroscopy analysis: further details about said analysis will be given in the examples which follow.

In the case of the epoxy groups, the polyisoprene rubber (b) preferably includes less than 10 mol %, preferably from 0.1 mol % to 5 mol %, of epoxy groups relative to the total number of moles of monomers present in the polyisoprene rubber.

The amount of the epoxy groups present on the epoxidized polyisoprene rubber (b) may be determined according to known techniques such as, for example, by means of ¹H-NMR analysis, or by hydrolysis of the epoxy groups and subsequent functionalization of the obtained hydroxyl groups by agents which are active to UV fluorescence analysis.

According to one preferred embodiment, said crosslinkable elastomeric composition may further comprise (d) from 0 phr to 40 phr, preferably from 5 phr to 30 phr, of at least one diene rubber other than butyl rubber.

According to one preferred embodiment, said crosslinkable elastomeric composition may further comprise (e) from 0 phr to 120 phr, preferably from 20 phr to 90 phr, of at least one carbon black reinforcing filler.

According to a further preferred embodiment, the present invention relates to a crosslinked manufactured article obtained by crosslinking a crosslinkable elastomeric composition above reported.

According to one preferred embodiment, the butyl rubber (a) may be selected from isobutyl rubbers.

Preferably, said isobutyl rubbers may be selected from homopolymers of isoolefin monomer containing from 4 to 12 carbon atoms or copolymers obtained by polymerizing a mixture comprising at least one isoolefin monomer containing from 4 to 12 carbon atoms and at least one conjugated diolefin monomer containing from 4 to 12 carbon atoms.

Preferably, said copolymers contain from 70% by weight to 99.5% by weight, preferably from 85% by weight to 95.5% by weight, based on the hydrocarbon content of the copolymer, of at least one isoolefin monomer and from 30% by weight to 0.5% by weight, preferably of from 15% by weight to 4.5% by weight, based on the hydrocarbon content of the copolymer, of at least one conjugated diolefin monomer.

Preferably, the isoolefin monomer may be selected from C₄-C₁₂ compounds such as, for example, isobutylene, isobutene, 2-methyl-1-butene, 3-methyl-1-butene, 2-methyl-2-butene, methyl vinyl ether, indene, vinyltrimethylsilane, hexene, 4-methyl-1-pentene, or mixtures thereof. Isobutylene is preferred.

Preferably, the conjugated diolefin monomer may be selected from C₄ to C₁₄ compounds such as, for example, isoprene, 1,3-butadiene, 2,3-dimethyl-1,3-butadiene, myrcene, 6,6-dimethyl-fulvene, hexadiene, cyclopentadiene, piperylene, or mixtures thereof. Isoprene is preferred.

Other polymerizable monomers such as, for example, styrene, styrene optionally substituted with C₁-C₄-alkyl groups or halogen groups, such as, for example, methylstyrene, dichlorostyrene, may also be present in the abovementioned isobutyl rubbers.

According to one preferred embodiment, the isobutyl rubbers may be selected from copolymers containing from 95% by weight to 99.5% by weight based on the hydrocarbon content of the copolymer of isobutylene and from 0.5% by weight to 5% by weight based on the hydrocarbon content of the copolymer of isoprene.

Further details regarding isobutyl rubbers and the methods for their preparation may be found, for example, in U.S. Pat. No. 2,356,128, U.S. Pat. No. 3,968,076, U.S. Pat. No. 4,474,924, U.S. Pat. No. 4,068,051 and U.S. Pat. No. 5,532,312.

Examples of commercially available isobutyl rubbers which may be used in the present invention are the products Exxon® butyl grade of poly(isobutylene-co-isoprene), or Vistanex® polyisobutylene rubber, from Exxon.

According to a further preferred embodiment, the butyl rubber (a) may be selected from halogenated butyl rubbers.

Halogenated butyl rubbers are derived from the butyl rubbers above reported by reaction with chlorine or bromine according to methods known in the art. For example, the butyl rubber may be halogenated in hexane diluent at from 40° C. to 60° C. using bromine or chlorine as the halogenation agent. Preferably, the halogen contents is from 0.1% by weight to 10% by weight, preferably from 0.5% by weight to 5% by weight, based on the weight of the halogenated butyl rubber.

Halogenated butyl rubbers that are particularly preferred according to the present invention are chlorobutyl rubber, or bromobutyl rubber.

Further details regarding the halogenated butyl rubbers and the methods for their preparation may be found, for example, in U.S. Pat. No. 2,631,984, U.S. Pat. No. 3,099,644, U.S. Pat. No. 4,554,326, U.S. Pat. No. 4,681,921, and U.S. Pat. No. 5,681,901.

Examples of commercially available chlorobutyl and bromobutyl rubbers which may be used in the present invention are the products Polysar® Chlorobutyl 1240, or Polysar® Bromobutyl 2030 from Bayer.

According to a further preferred embodiment, the butyl rubber (a) may be selected from a branched butyl rubber, “star-branched” butyl rubbers (SBB), or halogenated “star-branched” butyl rubber (HSSB).

Preferably, the star branched butyl rubber is a composition of a butyl rubber, either halogenated or not, and a polydiene or block copolymer, either halogenated or not. The polydiene/block copolymer or branching agents (hereinafter referred to as “polydienes”), are typically cationically reactive and are present during the polymerization of the butyl rubber, or may be blended with the butyl rubber to form the star branched butyl rubber.

More particularly, the star branched butyl rubber is typically a composition of the butyl or halogenated butyl rubber as disclosed above and a copolymer of a polydiene and a partially halogenated polydiene selected from the group comprising styrene, polybutadiene, polyisoprene, polypiperylene, natural rubber, styrene-butadiene rubber, ethylene-propylene diene rubber (EPDM), ethylene-propylene rubber (EPM), styrene-butadiene-styrene or styrene-isoprene-styrene block copolymers, or mixtures thereof. These polydienes are present, based on the monomer wt %, in an amount of from 0.3 wt % to 3 wt %, preferably of from 0.4 wt % to 2.7 wt %.

Further details regarding star branched or halogenated star branched butyl rubbers and methods for their preparation may be found, for example, in European Patent EP 678,529 and in U.S. Pat. No. 4,074,035, U.S. Pat. No. 5,071,913, U.S. Pat. No. 5,182,333, U.S. Pat. No. 5,286,804 and U.S. Pat. No. 6,228,978.

Examples of commercially available star branched butyl rubbers which may be used in the present invention are the products Exxon® SB butyl 4266, or Exxon® SB Bromobutyl 6222 from Exxon Mobil.

According to a further preferred embodiment, the butyl rubber (a) may be selected from halogenated isobutylene/p-alkylstyrene copolymers.

Said halogenated isobutylene/p-alkylstyrene copolymers may be selected from copolymers of an isoolefin containing from 4 to 7 carbon atoms such as, for example, isobutylene, and of a p-alkylstyrene such as, for example, p-methylstyrene. Said copolymers are known in the prior art and are disclosed, for example, in U.S. Pat. No. 5,162,445.

Preferred products are those derived from the halogenation of a copolymer between an isoolefin containing from 4 to 7 carbon atoms such as, for example, isobutylene, and a comonomer such as p-alkylstyrene in which at least one of the substituents on the alkyl groups present in the styrene unit is a halogen, preferably chlorine or bromine.

Further details regarding the preparation of halogenated isobutylene/p-alkylstyrene copolymers that are suitable for carrying out the present invention are disclosed, for example, in U.S. Pat. No. 5,512,638.

Examples of halogenated isobutylene/p-alkylstyrene copolymers which may be used in the present invention and which are currently commercially available include the Exxpro® products from Exxon Mobil.

According to one preferred embodiment the polyisoprene rubber (b) may be selected from natural or synthetic polyisoprene rubber, preferably from natural or synthetic cis-1,4-polyisoprene rubber, synthetic 3,4-polyisoprene, more preferably from natural cis-1,4-polyisoprene rubber (natural rubber).

As disclosed above, the polyisoprene rubber (b) may contain at least one functional group. Said functional group may be introduced into the polyisoprene rubber (b) by means of processes known in the art such as, for example, during the production of the polyisoprene rubber by co-polymerization with at least one corresponding functionalized monomer containing at least one ethylenic unsaturation; or by subsequent modification of the polyisoprene rubber by grafting said at least one functionalized monomer in the presence of a free radical initiator (for example, an organic peroxide).

Preferably, said functional group may be introduced into the polyisoprene rubber by means of a process comprising:

feeding at least one polyisoprene rubber and at least one functionalized monomer containing at least one ethylenic unsaturation into at least one extruder;

mixing and softening said mixture so as to obtain a polyisoprene rubber including at least one functional group;

discharge the polyisoprene rubber obtained in the above step from said at least one extruder.

Functionalized monomers which may be advantageously used include, for example, monocarboxylic or dicarboxylic acids containing at least one ethylenic unsaturation or derivatives thereof, in particular salts, anhydrides or esters.

Examples of monocarboxylic or dicarboxylic acids containing at least one ethylenic unsaturation or derivatives thereof are: maleic acid, fumaric acid, citraconic acid, itaconic acid, acrylic acid, methacrylic acid, and salts, anhydrides, or esters derived therefrom, or mixtures thereof. Maleic anhydride is particularly preferred.

With regard to the epoxy groups, the epoxy groups may be introduced during the production of the polyisoprene rubber, by co-polymerization with at least one epoxy compound containing at least one ethylenic unsaturation. Examples of epoxy compounds containing at least one ethylenic unsaturation are: glycidyl acrylate, glycidyl methacrylate, itaconic acid monoglycidyl ester, maleic acid glycidyl ester, vinylglycidyl ether, allylglycidyl ether, or mixtures thereof.

Alternatively, it is possible to introduce the epoxy groups by reacting the polyisoprene rubber, in solution, with at least one epoxidizing agent. This epoxidizing agent is, generally, a peroxide, a peracid, or a derivative thereof, in particular a salt thereof (for example, performic acid, perpropionic acid, peracetic acid, m-chloroperbenzoic acid, metal salts of peroxybenzoic acid such as, for example, magnesium bis(2-carboxylate-monoperoxybenzoic acid)hexahydrate) or, alternatively, hydrogen peroxide in the presence of a carboxylic acid or a derivative thereof, in particular anhydrides such as, for example, acetic acid, formic acid, propionic acid, acetic anhydride), optionally mixed with an acid catalyst (for example, sulphuric acid).

Further details regarding processes for epoxidizing polyisoprene rubber are disclosed, for example, in U.S. Pat. No. 4,341,672 or by Schulz et al. in “Rubber Chemistry and Technology”, Vol. 55, pages 809 et seq.

Preferably, the epoxy groups may be introduced into the polyisoprene rubber by means of a process comprising the following steps:

feeding at least one polyisoprene rubber and at least one epoxidizing agent into at least one extruder;

mixing and softening said mixture obtaining an epoxidized polyisoprene rubber;

discharging the obtained epoxidized polyisoprene rubber from said at least one extruder.

Alternatively, the epoxy groups may be introduced into the polyisoprene rubber by means of a process comprising:

feeding at least one polyisoprene rubber into at least one extruder;

feeding at least one hydrogen peroxide precursor to said at least one extruder;

feeding at least one carboxylic acid or a derivative thereof to said at least one extruder;

mixing and reacting, in the presence of water, said at least one polyisoprene rubber with said at least one hydrogen peroxide precursor and said at least one carboxylic acid or a derivative thereof, to obtain an epoxidized polyisoprene rubber;

discharging the resulting epoxidized polyisoprene rubber from said at least one extruder.

Preferably, the epoxidizing agent may be selected from those above reported.

Preferably, the hydrogen peroxide precursor may be selected, for example, from inorganic persalts (for example, sodium perborate mono- and tetra-hydrate, sodium percarbonate, potassium peroxymonosulfate), metal peroxides (for example, magnesium peroxide, calcium peroxide, zinc peroxide), hydrogen peroxide adducts (for example, urea/hydrogen peroxide adduct), or mixtures thereof.

Preferably the carboxylic acid or a derivative thereof may be selected, for example, from acetic acid, acetic anhydride, maleic acid, maleic anhydride, succinic acid, succinic anhydride, phthalic acid, phthalic anhydride, or mixtures thereof.

According to one preferred embodiment, the layered material (c) which may be used in the present invention may be selected, for example, from phyllosilicates such as: smectites, for example, montmorillonite, bentonite, nontronite, beidellite, volkonskoite, hectorite, saponite, sauconite; vermiculite; halloisite; sericite; aluminate oxides; hydrotalcite; or mixtures thereof. Montmorillonite, bentonite are particularly preferred. These layered materials generally contain exchangeable cations such as sodium (Na⁺), calcium (Ca²⁺), potassium (K⁺), or magnesium (Mg²⁺), present at the interlayer surfaces.

In order to render the layered material more compatible with the rubber, said layered material (c) may be optionally treated with at least one compatibilizing agent. Said compatibilizing agent is capable of undergoing ion exchange reactions with the cations present at the interlayers surfaces of the layered material.

Said compatibilizing agent may be selected, for example, from the quaternary ammonium or phosphonium salts having general formula (I):

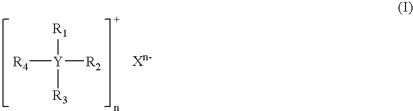

wherein:

Y represents N or P;

R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing hetero atom such as oxygen, nitrogen or sulfur;

Xⁿ⁻ represents an anion such as the chlorine ion, the sulfate ion or the phosphate ion;

n represents 1, 2 or 3.

The treatment of the layered material (c) with the compatibilizing agent may be carried out according to known methods such as, for example, by an ion exchange reaction between the layered material and the compatibilizing agent: further details are described, for example, in U.S. Pat. No. 4,136,103, U.S. Pat. No. 5,747,560 and U.S. Pat. No. 5,952,093.

According to one preferred embodiment, the layered inorganic material is untreated, i.e. it is not treated with a compatibilizing agent.

Example of layered materials (c) which may be used according to the present invention and are available commercially are the products known by the name of Cloisite® Na⁺ from Southern Clays, or Bentonite® AG/3 from Laviosa Chimica Mineraria S.p.A.

As reported above, the crosslinkable elastomeric composition may further comprise at least one diene rubber other than butyl rubber (d).

According to one preferred embodiment, the diene rubber (d) may be selected from those commonly used in sulfur-crosslinkable elastomeric compositions, that are particularly suitable for producing tires, that is to say from elastomeric polymers or copolymers with an unsaturated chain having a glass transition temperature (T_{g} generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid or alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene rubber (d) may be selected, for example, from: polybutadiene (in particular polybutadiene with a high 1,4-cis content), 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The above reported crosslinkable elastomeric composition may optionally comprise (d′) at least one elastomeric copolymer of ethylene and at least one α-olefin, optionally with a diene. The α-olefins generally contains from 3 to 12 carbon atoms, such as, for example, propylene, 1-butene, 1-pentene, 1-hexene, 1-octene, or mixtures thereof. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymer (EPR), ethylene/propylene/diene copolymers (EPDM); or mixtures thereof.

Optionally, the diene rubbers and the elastomeric copolymers above reported may be functionalized by reaction with suitable terminating agents or coupling agents. In particular, the diene rubbers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European Patent EP 451,604, or U.S. Pat. No. 4,742,124 and U.S. Pat. No. 4,550,142).

According to one preferred embodiment, said polyisoprene rubber, optionally containing at least one functional group, is pre-mixed with the layered material in order to obtain a masterbatch.

As disclosed above, said crosslinkable elastomeric composition may further comprise (e) at least one carbon black reinforcing filler.

According to one preferred embodiment, the carbon black reinforcing filler which may be used in the present invention may be selected from those having a surface area of not less than 20 m²/g (determined by CTAB absorption as described in Standard ISO 6810:1995).

At least one additional reinforcing filler may advantageously be added to the above reported elastomeric composition, in an amount generally of from 0 phr to 120 phr, preferably of from 20 phr to 90 phr. The reinforcing filler may be selected from those commonly used for crosslinked manufactured products, in particular for tires, such as, for example, silica, alumina, aluminosilicates, calcium carbonate, kaolin, or mixtures thereof.

The silica which may be used in the present invention may generally be a pyrogenic silica or, preferably, a precipitated silica, with a BET surface area (measured according to ISO standard 5794/1) of from 50 m²/g to 500 m²/g, preferably of from 70 m²/g to 200 m²/g.

When a reinforcing filler comprising silica is present, the elastomeric composition may advantageously incorporate a silane coupling agent capable of interacting with the silica and of linking it to the elastomeric polymer during the vulcanization.

According to one preferred embodiment, the silane coupling agent may be selected from those having at least one hydrolyzable silane group which may be identified, for example, by the following general formula (II):

(R)₃Si—CₙH₂ₙ—X (II)

wherein the groups R, which may be identical or different, are selected from: alkyl, alkoxy or aryloxy groups, or from halogen atoms, on condition that at least one of the groups R is an alkoxy or aryloxy group; n is an integer between 1 and 6 inclusive; X is a group selected from: nitroso, mercapto, amino, epoxy, vinyl, imido, chloro, —(S)ₘCₙH₂ₙ—Si—(R)₃, or —S—COR, in which m and n are integers between 1 and 6 inclusive and the groups R are defined as above.

Among the silane coupling agents that are particularly preferred are bis(3-triethoxysilyl-propyl)tetrasulphide, or bis(3-triethoxysilylpropyl)-disulphide. Said coupling agents may be used as such or as a suitable mixture with an inert filler (for example carbon black) so as to facilitate their incorporation into the rubber used.

According to one preferred embodiment, said silane coupling agent is present in the crosslinkable elastomeric composition in an amount of from 0 phr to 10 phr, preferably of from 0.5 phr to 5 phr.

The crosslinkable elastomeric composition above reported may be vulcanized according to known techniques, in particular with sulfur-based vulcanizing systems commonly used for elastomeric polymers. To this end, in the composition, after one or more steps of thermal-mechanical processing, a sulfur-based vulcanizing agent is incorporated together with vulcanization accelerators. In the final processing step, the temperature is generally kept below 120° C. and preferably below 100° C., so as to avoid any unwanted pre-crosslinking phenomena.

The vulcanizing agent most advantageously used is sulfur, or molecules containing sulfur (sulfur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulfenamides, thiurams, amines, xanthates, or mixtures thereof.

Said crosslinkable elastomeric composition may comprise other commonly used additives selected on the basis of the specific application for which the composition is intended. For example, the following may be added to said elastomeric composition: antioxidants, anti-ageing agents, plasticizers, adhesives, anti-ozone agents, modifying resins, fibers (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to said elastomeric composition. The amount of plasticizer generally ranges from 0 phr to 70 phr, preferably from 5 phr to 30 phr.

The above reported crosslinkable elastomeric composition may be prepared by mixing together the rubber components and the layered material or a masterbatch thereof, with the reinforcing filler and the other additives optionally present, according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss), or of co-rotating or counter-rotating twin-screw type.

### BRIEF DESCRIPTION OF THE DRAWING

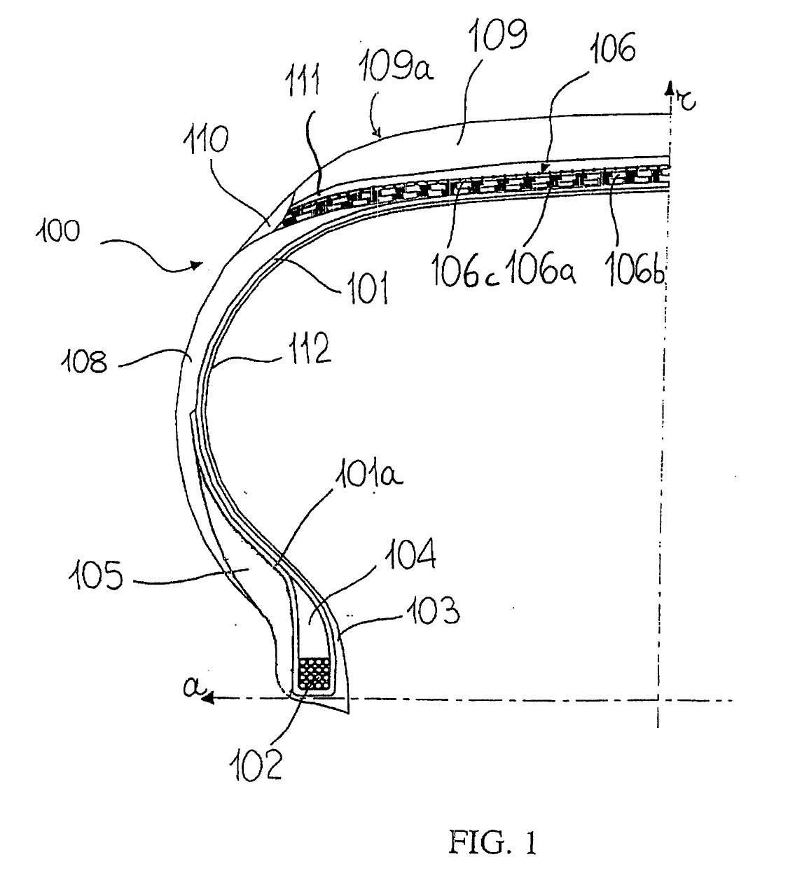

The present invention will now be illustrated in further detail by means of the attached FIG. 1 which is a view in cross section of a portion of a tire made according to the invention

“a” indicates an axial direction and “r” indicates a radial direction. For simplicity, FIG. 1 shows only a portion of the tire, the remaining portion not represented being identical and symmetrically arranged with respect to the radial direction “r”.

### DETAILED DESCRIPTION OF THE PREFERRED EMBODIMENTS

The tire (100) comprises at least one carcass ply (101), the opposite lateral edges of which are associated with respective bead structures comprising at least one bead core (102) and at least one bead filler (104). The association between the carcass ply (101) and the bead core (102) is achieved here by folding back the opposite lateral edges of the carcass ply (101) around the bead core (102) so as to form the so-called carcass back-fold (101a) as shown in FIG. 1.

Alternatively, the conventional bead core (102) can be replaced with at least one annular insert formed from rubberized wires arranged in concentric coils (not represented in FIG. 1) (see, for example, European Patent Applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of a crosslinked elastomeric material which may be made according to the present invention. These reinforcing cords are usually made of textile fibers, for example rayon, nylon or polyethylene terephthalate, or of steel wires stranded together, coated with a metal alloy (for example copper/zinc, zinc/manganese, zinc/molybdenum/cobalt alloys, and the like).

The carcass ply (101) is usually of radial type, i.e. it incorporates reinforcing cords arranged in a substantially perpendicular direction relative to a circumferential direction. The core (102) is enclosed in a bead (103), defined along an inner circumferential edge of the tire (100), with which the tire engages on a rim (not represented in FIG. 1) forming part of a vehicle wheel. The space defined by each carcass back-fold (101a) contains a bead filler (104) which may be made according to the present invention, wherein the bead core (102) is embedded. An anti-abrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A tread underlayer (111), is placed between the belt structure (106) and the tread band (109).

As represented in FIG. 1, the tread underlayer (111) may have uniform thickness.

Alternatively, the tread underlayer (111) may have a variable thickness in the transversal direction. For example, the thickness may be greater near its outer edges than at a central zone.

In FIG. 1, said tread underlayer (111) extends over a surface substantially corresponding to the surface of development of said belt structure (106). Alternatively, said tread underlayer (111) extends only along at least one portion of the development of said belt structure (106), for instance at opposite side portions of said belt structure (106) (not represented in FIG. 1).

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

In the case of tubeless tires, an innerliner (112), which may be made according to the present invention, which provides the necessary impermeability to the inflation air of the tire, may be provided in an inner position relative to the carcass ply (101).

In the case of a tire provided with an innertube (not represented in FIG. 1), said innertube may be made according to the present invention.

The process for producing the tire according to the present invention may be carried out according to techniques and using apparatus that are known in the art, as described, for example, in European Patent EP 199,064, and in U.S. Pat. No. 4,872,822 and U.S. Pat. No. 4,768,937, said process including at least one stage of manufacturing the crude tire and at least one stage of vulcanizing this tire.

More particularly, the process for producing the tire comprises the steps of preparing, beforehand and separately from each other, a series of semi-finished products corresponding to the various structural elements of the tire (carcass plies, belt structure, bead wires, fillers, sidewalls, innerliner and tread band) which are then combined together using a suitable manufacturing machine. Next, the subsequent vulcanization step welds the abovementioned semi-finished products together to give a monolithic block, i.e. the finished tire.

The step of preparing the abovementioned semi-finished products will be preceded by a step of preparing and molding the various crosslinkable elastomeric compositions, of which said semi-finished products are made, according to conventional techniques.

The crude tire thus obtained is then passed to the subsequent steps of molding and vulcanization. To this end, a vulcanization mould is used which is designed to receive the tire being processed inside a molding cavity having walls which are countermolded to define the outer surface of the tire when the vulcanization is complete.

Alternative processes for producing a tire or parts of a tire without using semi-finished products are disclosed, for example, in the abovementioned European Patent Applications EP 928,680 and EP 928,702. According to one preferred embodiment, said layer including a crosslinked elastomeric material (for example, said innerliner) is formed by a plurality of coils of a continuous elongated element. Said elongated element may be produced, for example, by extruding the crosslinkable elastomeric composition above disclosed. Preferably, said layer is assembled onto a support.

For the purposes of the present description and of the claims which follow, the term “support” is used to indicate the following devices:

an auxiliary drum having a cylindrical shape, said auxiliary drum preferably supporting a belt structure;

a shaping drum having a substantially toroidal configuration, said shaping drum preferably supporting at least one carcass structure with a belt structure assembled thereon;

a rigid support preferably shaped according to the inner configuration of the tire.

Further details regarding said devices and the methods of forming and/or depositing the above mentioned layer on a support are described, for example, in International Patent Application WO 01/36185 and in European Patent EP 976,536 in the name of the Applicant, and in European Patent Applications: EP 968,814, EP 1,201,414 and EP 1,211,057.

The crude tire can be molded by introducing a pressurized fluid into the space defined by the inner surface of the tire, so as to press the outer surface of the crude tire against the walls of the molding cavity. In one of the molding methods widely practiced, a vulcanization chamber made of elastomeric material, filled with steam and/or another fluid under pressure, is inflated inside the tire closed inside the molding cavity. In this way, the crude tire is pushed against the inner walls of the molding cavity, thus obtaining the desired molding. Alternatively, the molding may be carried out without an inflatable vulcanization chamber, by providing inside the tire a toroidal metal support shaped according to the configuration of the inner surface of the tire to be obtained as described, for example, in European Patent EP 1,189,744.

At this point, the step of vulcanizing the crude tire is carried out. To this end, the outer wall of the vulcanization mould is placed in contact with a heating fluid (generally steam) such that the outer wall reaches a maximum temperature generally of from 100° C. to 230° C. Simultaneously, the inner surface of the tire is heated to the vulcanization temperature using the same pressurized fluid used to press the tire against the walls of the molding cavity, heated to a maximum temperature of from 100° C. to 250° C. The time required to obtain a satisfactory degree of vulcanization throughout the mass of the elastomeric material may vary in general from 3 min to 90 min and depends mainly on the dimensions of the tire. When the vulcanization is complete, the tire is removed from the vulcanization mould.

The present invention will be further illustrated below by means of a number of preparation examples, which are given for purely indicative purposes and without any limitation of this invention.

### Example 1

### Preparation of the Elastomeric Polymer Including a Functional Group in a Twin-Screw Extruder

The amounts of the compounds used are given in Table 1 (the amounts of the various components are given in phr).

TABLE 1

| | EXAMPLE |
|---|---|
| | 1 |
| NR | 100 |
| maleic anhydride | 2 |
| polyethylene wax | 4 |

NR: natural rubber;
maleic anhydride: commercial product from Lonza;
polyethylene wax: Ceridust ® 3620 (Clariant).

The natural rubber was obtained in the form of granules having an average particles size diameter of about 3 mm-20 mm by means of a rubber grinder. The so obtained granules and maleic anhydride, also in a granular form, were fed to the feed hopper of a co-rotating twin-screw extruder Maris TM40HT having a nominal screw diameter of 40 mm and a L/D ratio of 48. The maximum temperature in the extruder was 180° C. The extrusion head was kept at a temperature of 40° C.

The obtained modified natural rubber was discharged from the extruder in the form of a continuous strand, was cooled at room temperature in a cooling device and granulated. A sample of the obtained modified natural rubber was subjected to Infrared ATR-Spectroscopy analysis below reported in order to evaluate the amount of the grafted maleic anhydride.

### IR Analysis

The modified natural rubber obtained as above disclosed was subjected to Infrared ATR-Spectroscopy analysis.

A thin plate of the modified natural rubber (0.5 g weight) was obtained by pressure die-casting, under vacuum, at 70° C.

The obtained thin plate was put in a Soxhlet apparatus in order to extract the non-grafted maleic anhydride: the extraction was carried out in a toluene:ethanol (70:30) solvent mixture, for 8 hours, at the reflux temperature of the solvent.

The amount of the grafted maleic anhydride was calculated by means of a calibration curve.

The signals used are the following: the signal at 1780 cm⁻¹ which refers to the C═O stretching of the acid form of the carbonyl group of the maleic anhydride (open form of the maleic anhydride) and the signal at 840 cm⁻¹ which refers to the bending of the C═C group of natural rubber.

The amount of the grafted maleic anhydride was calculated from the ratio between the area of the signal corresponding to maleic anhydride and the area of the signal corresponding to natural rubber by means of a calibration curve.

The elastomeric polymer was found to include 0.6% by weight of grafted maleic anhydride with respect to the total weight of the elastomeric polymer.

### Examples 2-5

### Preparation of the Elastomeric Compositions

The elastomeric compositions given in Table 2 were prepared as follows (the amounts of the various components are given in phr).

All the components, except sulfur and accelerator (MBTS), were mixed together in an internal mixer (model Pomini PL 1.6) for about 5 min (1^{st} Step). As soon as the temperature reached 145±5° C., the elastomeric material was discharged. The sulfur and the accelerator, were then added and mixing was carried out in an open roll mixer (2^{nd} Step).

TABLE 2

EXAMPLE

| | | | |
|---|---|---|---|
| 2 (*) | 3 | 4 | 5 |

1^{st} STEP

| | | | | |
|---|---|---|---|---|
| NR | 55 | 55 | — | 55 |
| NR-g-MAH | — | — | 55 | — |
| CIIR | 20 | 20 | 20 | 20 |
| E-SBR | 25 | 25 | 25 | 25 |
| N660 | 33 | 33 | 33 | 33 |
| Zinc oxide | 3.5 | 3.5 | 3.5 | 3.5 |
| Stearic acid | 2.0 | 2.0 | 2.0 | 2.0 |
| Antioxidant | 0.5 | 0.5 | 0.5 | 0.5 |
| Calcium carbonate | 30 | 19 | 19 | — |
| Cloisite ® Na⁺ | — | 11 | 11 | — |
| Bentonite ® AG/3 | — | — | — | 30 |

2^{nd} STEP

| | | | | |
|---|---|---|---|---|
| MBTS | 1.0 | 1.0 | 1.0 | 1.0 |
| Sulfur | 2.2 | 2.2 | 2.2 | 2.2 |

(*): comparative.
NR: natural rubber;
NR-g-MAH: functionalized natural rubber obtained in Example 1;
CIIR: chlorinated isobutylene/isoprene copolymer with a halogen content of 1.2% by weight (Polysar ® Chlorobutyl 1240 from Bayer);
E-SBR: emulsion prepared butadiene-styrene copolymer (SBR 1712 NF from Polimeri Europa);
N660: carbon black;
Antioxidant: phenyl-p-phenylenediamine;
Cloisite ® Na⁺: untreated montmorillonite belonging to the smectite family (Southern Clays);
Bentonite ® AG/3: untreated bentonite having high sodium content (1-1.5%) belonging to the smectite family (Dal Cin S.p.A.);
MBTS (accelerator): dibenzothiazyldisulfide (Vulkacit ® DM/C-Bayer).

The Mooney viscosity ML(1+4) at 100° C. was measured, according to Standard ISO 289-1:1994, on the non-crosslinked elastomeric compositions obtained as described above. The results obtained are given in Table 5.

The static mechanical properties according to Standard ISO 37:1994 as well as hardness in IRHD degrees at 23° C. according to ISO standard 48:1994, were measured on samples of the abovementioned elastomeric compositions vulcanized at 170° C. for 10 min. The results obtained are given in Table 5.

Table 5 also shows the dynamic mechanical properties, measured using an Instron dynamic device in the traction-compression mode according to the following methods. A test piece of the crosslinked elastomeric composition (vulcanized at 170° C. for 10 min) having a cylindrical form (length=25 mm; diameter=12 mm), compression-preloaded up to a 10% longitudinal deformation with respect to the initial length, and kept at the prefixed temperature (23° C. or 70° C.) for the whole duration of the test, was submitted to a dynamic sinusoidal strain having an amplitude of ±3.5% with respect to the length under pre-load, with a 100 Hz frequency. The dynamic mechanical properties are expressed in terms of dynamic elastic modulus (E′) and Tan delta (Goss factor) values. The Tan delta value is calculated as a ratio between viscous modulus (E″) and elastic modulus (E′).

The permeability was measured, at 23° C., according to ISO standard 2782:1995, on samples of the crosslinked elastomeric composition (vulcanized at 170° C. for 10 min). To this purpose, test pieces having a diameter of 120 mm and a nominal thickness of 1 mm, were conditioned at 23° C. for 16 hours and then subjected to the permeability test: the obtained data are given in Table 5. In Table 5, the numbers relative the air permeability are shown by taking the value of comparative Example 1 as 100: the lower the number, the better the air permeation resistance.

Finally, the flexural fatigue resistance, at 70° C., according to ISO standard 132:199 (De Mattia test), on samples of the crosslinked elastomeric composition (vulcanized at 170° C. for 10 min), was measured. To this purpose, test pieces were conditioned at room temperature (23° C.) for 16 hours and then subjected to the following measurement:

number of cycles at which the tear start;

number of cycles at which the complete break of the pieces start (the pieces were subjected to a maximum of 300 kcicles).

The obtained data are given in Table 3.

TABLE 3

| | EXAMPLE | | | |
|---|---|---|---|---|
| | 2 (*) | 3 | 4 | 5 |
| Mooney | 41.8 | 45.0 | 55.4 | 51.7 |
| viscosity ML | | | | |
| (1 + 4) | | | | |

STATIC MECHANICAL PROPERTIES

| | | | | |
|---|---|---|---|---|
| 100% Modulus | 1.38 | 1.60 | 2.20 | 1.61 |
| (MPa) | | | | |
| 300% Modulus | 4.51 | 4.70 | 6.50 | 4.70 |
| (MPa) | | | | |
| Stress at break | 10.25 | 10.40 | 12.10 | 8.82 |
| (MPa) | | | | |

DYNAMIC MECHANICAL PROPERTIES

| | | | | |
|---|---|---|---|---|
| E′ (23° C.) (MPa) | 4.47 | 5.41 | 5.80 | 5.37 |
| E′ (70° C.) (MPa) | 3.30 | 3.84 | 4.04 | 3.80 |
| Tandelta (23° C.) | 0.27 | 0.28 | 0.25 | 0.28 |
| Tandelta (70° C.) | 0.12 | 0.13 | 0.13 | 0.14 |
| IRHD Hardness | 52.00 | 53.10 | 56.30 | 53.20 |
| (23° C.) | | | | |
| Permeability | 100 | 68.30 | 56.10 | 59.10 |
| (23° C.) | | | | |

FLEXURAL FATIGUE RESISTANCE (DE MATTIA TEST)

| | | | | |
|---|---|---|---|---|
| Start tear | 80.29 | 107.42 | no tear | 107.42 |
| (kcicles) | | | | |
| Complete break | no break | no break | no break | no break |
| (kcicles) | | | | |

(*): comparative.

1-57. (canceled)

58. A tire comprising:
a carcass structure comprising at least one carcass ply of a substantially toroidal shape having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure; and
at least one layer comprising a crosslinked elastomeric material applied in a radially inner position with respect to said carcass structure,
wherein said crosslinked elastomeric material is obtained by crosslinking a crosslinkable elastomeric composition comprising:
(a) less than 50 phr of at least one butyl rubber;
(b) not less than 50 phr of at least one polyisoprene rubber; and
(c) 2 phr to 50 phr of at least one layered material.

59. The tire according to claim 58, wherein said crosslinkable elastomeric composition comprises 15 phr to 40 phr of at least one butyl rubber.

60. The tire according to claim 58, wherein said crosslinkable elastomeric composition comprises 60 phr to 85 phr of at least one polyisoprene rubber.

61. The tire according to claim 58, wherein said crosslinkable elastomeric composition comprises 5 phr to 35 phr of at least one layered material.

62. The tire according to claim 58, wherein said polyisoprene rubber comprises at least one functional group selected from: carboxylic groups, carboxylate groups, anhydride groups, ester groups, and epoxy groups.

63. The tire according to claim 62, wherein said polyisoprene rubber comprises 0.05% by weight to 10% by weight, with respect to the total weight of the polyisoprene rubber, of said at least one functional group selected from: carboxylic groups, carboxylate groups, anhydride groups, and ester groups.

64. The tire according to claim 62, wherein said polyisoprene rubber comprises less than 10 mol % of epoxy groups relative to the total number of moles of monomers present in the polyisoprene rubber.

65. The tire according to claim 58, wherein said layer comprising a crosslinked elastomeric material is a tire innerliner.

66. The tire according to claim 58, wherein said butyl rubber is selected from isobutyl rubbers.

67. The tire according to claim 66, wherein said isobutyl rubbers are selected from homopolymers of isoolefin monomer containing from 4 to 12 carbon atoms or copolymers obtained by polymerizing a mixture comprising at least one isoolefin monomer containing from 4 to 12 carbon atoms and at least one conjugated diolefin monomer containing from 4 to 12 carbon atoms.

68. The tire according to claim 58, wherein the butyl rubber is selected from halogenated butyl rubbers.

69. The tire according to claim 68, wherein said halogenated butyl rubbers are chlorobutyl rubber or bromobutyl rubber.

70. The tire according to claim 58, wherein the butyl rubber is selected from a branched butyl rubber, star-branched butyl rubbers, or halogenated star-branched butyl rubber.

71. The tire according to claim 58, wherein the butyl rubber is selected from halogenated isobutylene/p-alkylstyrene copolymers.

72. The tire according to claim 58, wherein the polyisoprene rubber is selected from natural or synthetic polyisoprene rubber, natural or synthetic cis-1,4-polyisoprene rubber, or synthetic 3,4-polyisoprene.

73. The tire according to claim 72, wherein the polyisoprene rubber is natural cis-1,4-polyisoprene rubber (natural rubber).

74. The tire according to claim 58, wherein said layered material is selected from phyllosilicates, smectites, montmorillonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof.

75. The tire according to claim 74, wherein said layered material is montmorillonite or bentonite.

76. The tire according to claim 74, wherein said layered material is treated with a compatibilizing agent.

77. The tire according to claim 76, wherein said compatibilizing agent is selected from the quaternary ammonium or phosphonium salts having general formula (I): 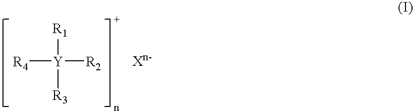
wherein:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH, wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group optionally containing a hetero atom, oxygen, nitrogen or sulfur;
Xⁿ⁻ represents an anion, chlorine ion, sulfate ion or phosphate ion; and
n represents 1, 2 or 3.

78. The tire according to claim 74, wherein said layered material is not treated with a compatibilizing agent.

79. The tire according to claim 74, wherein said layered material has an individual layer thickness of 0.01 nm to 30 nm.

80. The tire according to claim 79, wherein said layered material has an individual layer thickness of 0.05 nm to 15 nm.

81. The tire according to claim 58, wherein said crosslinkable elastomeric composition further comprises at least one diene rubber other than butyl rubber.

82. The tire according to claim 81, wherein said diene rubber other than butyl rubber is selected from: polybutadiene, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

83. The tire according to claim 58, wherein said crosslinkable elastomeric composition further comprises at least one elastomeric copolymer of ethylene and at least one α-olefin, optionally with a diene.

84. The tire according to claim 83, wherein said elastomeric copolymer of ethylene and at least one α-olefin, optionally with a diene, is selected from: ethylene/propylene copolymer, ethylene/propylene/diene copolymers, or mixtures thereof.

85. The tire according to claim 58, wherein said crosslinkable elastomeric composition further comprises 0 phr to 120 phr of at least one carbon black reinforcing filler.

86. The tire according to claim 85, wherein said crosslinkable elastomeric composition further comprises 20 phr to 90 phr of at least one carbon black reinforcing filler.

87. The tire according to claim 58, wherein said crosslinkable elastomeric composition further comprises silica.

88. The tire according to claim 87, wherein said crosslinkable-elastomeric composition further comprises a silane coupling agent selected from a silane having at least one hydrolyzable silane group which may be identified by the following general formula (II):
(R)₃Si—CₙH₂ₙ—X (II)
wherein R, which may be identical or different, is selected from alkyl, alkoxy or aryloxy groups or from halogen atoms, on condition that at least one R group is an alkoxy or aryloxy group; n is an integer between 1 and 6 inclusive; X is a group selected from: nitroso, mercapto, amino, epoxide, vinyl, imido, chloro, —(S)ₘCₙH₂ₙSi—(R)₃ or —S—COR in which m and n are integers between 1 and 6 inclusive, and R is defined as above.

89. The tire according to claim 88, wherein said silane coupling agent is present in the crosslinkable elastomeric composition in an amount of 0 phr to 10 phr.

90. The tire according to claim 58, wherein said at least one carcass ply comprises a crosslinked elastomeric material which is obtained by crosslinking a crosslinkable elastomeric composition comprising:
(a) less than 50 phr of at least one butyl rubber;
(b) not less than 50 phr of at least one polyisoprene rubber; and
(c) 2 phr to 50 phr of at least one layered material.

91. The tire according to claim 90, wherein said crosslinkable elastomeric composition comprises 15 phr to 40 phr of at least one butyl rubber.

92. The tire according to claim 90, wherein said crosslinkable elastomeric composition comprises 60 phr to 85 phr of at least one polyisoprene rubber.

93. The tire according to claim 90, wherein said crosslinkable elastomeric composition comprises 5 phr to 35 phr of at least one layered material.

94. The tire according to claim 90, wherein said butyl rubber is selected from halogenated butyl rubbers.

95. The tire according to claim 90, wherein said polyisoprene rubber comprises at least one functional group selected from: carboxylic groups, carboxylate groups, anhydride groups, ester groups and epoxy groups or wherein the polyisoprene rubber comprises natural or synthetic polyisoprene rubber, natural or synthetic cis-1,4-polyisoprene rubber, or synthetic 3,4-polyisoprene.

96. The tire according to claim 90, wherein said layered material comprises phyllosilicates, smectites, montmorillonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof.

97. The tire according to claim 90, wherein said crosslinkable elastomeric composition further comprises at least one diene rubber other than butyl rubber, or wherein said crosslinkable elastomeric composition further comprises at least one elastomeric copolymer of ethylene and at least one α-olefin, optionally with a diene, or wherein said crosslinkable elastomeric composition further comprises silica.

98. A tire comprising:
a carcass structure comprising at least one carcass ply of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
at least one innertube which fits inside said carcass structure,
wherein said at least one innertube comprises a crosslinked elastomeric material which is obtained by crosslinking a crosslinkable elastomeric composition comprising:
(a) less than 50 phr of at least one butyl rubber;
(b) not less than 50 phr of at least one polyisoprene rubber; and
(c) 2 phr to 50 phr of at least one layered material.

99. The tire according to claim 98, wherein said crosslinkable elastomeric composition comprises 15 phr to 40 phr of at least one butyl rubber.

100. The tire according to claim 98, wherein said crosslinkable elastomeric composition comprises 60 phr to 85 phr of at least one polyisoprene rubber.

101. The tire according to claim 98, wherein said crosslinkable elastomeric composition comprises 5 phr to 35 phr of at least one layered material.

102. The tire according to claim 98, wherein the butyl rubber is selected from isobutyl rubbers, or wherein the butyl rubber is selected from halogenated butyl rubbers, or wherein the butyl rubber is selected from halogenated isobutylene/p-alkylstyrene copolymers.

103. The tire according to claim 98, wherein said polyisoprene rubber comprises at least one functional group selected from: carboxylic groups, carboxylate groups, anhydride groups, ester groups, and epoxy groups, or wherein the polyisoprene rubber comprises natural or synthetic polyisoprene rubber, natural or synthetic cis-1,4-polyisoprene rubber, or synthetic 3,4-polyisoprene.

104. The tire according to claim 98, wherein said layered material comprises phyllosilicates, smectites, montmorillonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof.

105. The tire according to claim 98, wherein said crosslinkable elastomeric composition further comprises at least one diene rubber other than butyl rubber, or wherein said crosslinkable elastomeric composition further comprises at least one elastomeric copolymer of ethylene and at least one α-olefin, optionally with a diene, or wherein said crosslinkable elastomeric composition further comprises silica.

106. A crosslinkable elastomeric composition comprising:
(a) less than 50 phr of at least one butyl rubber;
(b) not less than 50 phr of at least one polyisoprene rubber; and
(c) 2 phr to 50 phr of at least one layered material.

107. The crosslinkable elastomeric composition according to claim 106, wherein said crosslinkable elastomeric composition comprises 15 phr to 40 phr of at least one butyl rubber.

108. The crosslinkable elastomeric composition according to claim 106, wherein said crosslinkable elastomeric composition comprises 60 phr to 85 phr of at least one polyisoprene rubber.

109. The crosslinkable elastomeric composition according to claim 106, wherein said crosslinkable elastomeric composition comprises 5 phr to 35 phr of at least one layered material.

110. The crosslinkable elastomeric composition according claim 106, wherein said butyl rubber is selected from isobutyl rubbers, or wherein the butyl rubber is selected from halogenated butyl rubbers, or wherein the butyl rubber is selected from halogenated isobutylene/p-alkylstyrene copolymers.

111. The crosslinkable elastomeric composition according to claim 106, wherein said polyisoprene rubber comprises at least one functional group selected from: carboxylic groups, carboxylate groups, anhydride groups, ester groups, and epoxy groups, or wherein the polyisoprene rubber comprises natural or synthetic polyisoprene rubber, natural or synthetic cis-1,4-polyisoprene rubber, or synthetic 3,4-polyisoprene.

112. The crosslinkable elastomeric composition according to claim 106, wherein said layered material comprises phyllosilicates, smectites, montmorillonite, nontronite, beidellite, volkonskoite, laponite, hectorite, saponite, sauconite, magadite, kenyasite, stevensite, vermiculite, halloisite, sericite, aluminate oxides, hydrotalcite, or mixtures thereof.

113. The crosslinkable elastomeric composition according to claim 106, wherein said crosslinkable elastomeric composition further comprises at least one diene rubber other than butyl rubber, or wherein said crosslinkable elastomeric composition further comprises at least one elastomeric copolymer of ethylene and at least one α-olefin, optionally with a diene, or wherein said crosslinkable elastomeric composition further comprises silica.

114. A crosslinked manufactured article obtained by crosslinking a crosslinkable elastomeric composition defined according to claim 106.
